(19) United States
(12) Patent Application Publication
(10) Pub. No.: US 2014/0091698 A1
(43) Pub. Date: Apr. 3, 2014

(54) Lamp Device and Lighting Apparatus

(71) Applicant: TOSHIBA LIGHTING & TECHNOLOGY CORPORATION, Yokosuka-shi (JP)

(72) Inventors: Junichi Kimiya, Yokosuka-shi (JP); Kenji Nezu, Yokosuka-shi (JP); Kazunari Higuchi, Yokosuka-shi (JP); Makoto Otsuka, Tokyo (JP); Takeshi Osada, Yokosuka-shi (JP); Yoshiyuki Tamaki, Yokosuka-shi (JP)

(73) Assignee: TOSHIBA LIGHTING & TECHNOLOGY CORPORATION, Yokosuka-shi (JP)

(21) Appl. No.: 14/014,587

(22) Filed: Aug. 30, 2013

(30) Foreign Application Priority Data
Sep. 28, 2012 (JP) 2012-215925
Sep. 28, 2012 (JP) 2012-215926

(51) Int. Cl. F21V 29/00

(52) U.S. Cl. CPC F21V 29/004
USPC 313/47; 313/116; 313/113

(57) ABSTRACT

A lamp device includes a substrate body, a light source part mounted on the substrate body, and a contact portion electrically connected to the light source part. A cover receives the light source part in a space formed by the cover and the substrate body, is light transmissive at least at a position facing the light source part, and spatially separates the light source part mounted on the substrate body and the contact portion.

### CROSS-REFERENCE TO RELATED APPLICATIONS

This application is based upon and claims the benefit of priority from the prior Japanese Patent Applications No. 2012-215925 and 2012-215926, filed on Sep. 28, 2012, the entire contents of which are incorporated herein by reference.

### FIELD

Embodiments described herein relates generally to a lamp device and a lighting apparatus, in which an apparatus body is provided with a thermal radiator including a connection part which a lamp contacts and is thermally connected to.

### BACKGROUND

Formerly, as a flat lamp used for a lighting apparatus, such as a down light, embedded and arranged on an installation surface such as a ceiling, there is a lamp using, for example, a GH76P cap. This lamp includes a light-emitting module substrate including an LED element of a semiconductor light-emitting element as a light source, a housing which houses the light-emitting module substrate and has a translucent lower part facing the light-emitting module substrate, a cap which is provided on an upper side of the housing and has a pair of lamp pins, and a thermal radiation sheet disposed on the cap. In this lamp, after the cap is pressed to a socket attached to an apparatus body of the lighting apparatus, the cap is rotated by a specified angle, so that the lamp is installed to the socket. In this installation state, the cap is electrically connected to a power supply side. The thermal radiation sheet contacts a thermal radiator of the apparatus body and is thermally connected, so that heat generated in the LED element can be radiated. As related art of this type of lamp, there is, for example, JP-A-2012-109157.

However, in the foregoing lamp, since the electric contact part and the light-emitting module are arranged in the same space, there is a possibility that deterioration due to heat generation or the like is caused.

Further, in the foregoing lamp, since the lamp is rotated relative to the socket and is connected, an engagement structure between the socket and the lamp cap and an assembling process become complicated and the cost increases. Besides, in order to cause the contact surface of the thermal radiation sheet with the thermal radiator to have a sliding property so that the lamp can be smoothly rotated relative to the socket, the thermal radiation sheet is covered with, for example, a separate metal foil or the like harder than the thermal radiation sheet. Thus, heat resistance to thermal radiation from the light-emitting module substrate increases, and heat loss occurs in the connection structure between the cap and the socket.

### BRIEF DESCRIPTION OF THE DRAWINGS

FIG. 1 is a sectional view showing a part of a lighting apparatus of a first embodiment.

FIG. 2 is a sectional view showing a part of a state just before a lamp device of the lighting apparatus is installed.

FIG. 3 is a perspective view showing the vicinity of a contact of the lamp device.

FIG. 4 is a perspective view showing the vicinity of a terminal of a socket.

FIG. 5 is a perspective view when the lamp device is seen from below.

FIG. 6 is a perspective view when the lamp device is seen from above.

FIG. 7 is a plan view of the socket.

FIG. 8A and FIG. 8B are perspective views before the lamp device is attached to the socket device.

FIG. 9 is a sectional view of a lighting apparatus showing a state where a reflector is attached.

FIG. 10 is a perspective view of the lighting apparatus showing the state where the reflector is attached.

### DETAILED DESCRIPTION

In view of the above circumstances, according to one embodiment, a lamp device and a lighting apparatus are provided, in which deterioration of an electric contact part is suppressed.

Also, according to the embodiment, a lamp device and a lighting apparatus are provided which are inexpensive and have excellent heat radiation properties.

In general, according to one embodiment, a lamp device includes a substrate body, a light source mounted on the substrate body, and a contact portion electrically connected to the light source. A cover accommodates the light source in a space formed by the cover and the substrate body, is light transmissive, namely, translucent at least at a position facing the light source, and spatially separates the light source part disposed on the substrate body and the contact portion.

According to this embodiment, the light source part disposed on the substrate body and the electric contact part are spatially separated, so that the lamp device and the lighting apparatus are provided, in which deterioration of the electric contact part is suppressed.

In addition, according to one aspect of the embodiment, a lamp device includes a substrate body, a light source mounted on the substrate body, and a contact portion electrically connected to the light source. A cover receives, namely, accommodates the light source in a space formed by the cover and the substrate body, is light transmissive at least at a position facing the light source, and has a locking part engaged with a socket side engagement part. If desired, the cover spatially separates the light source part disposed on the substrate body and the contact portion as described.

According to the aspect of this embodiment, since the cover of the lamp device is provided with the engagement unit in the socket, the lamp device and the lighting apparatus can be provided, in which the number of parts is decreased and the assembly is easy.

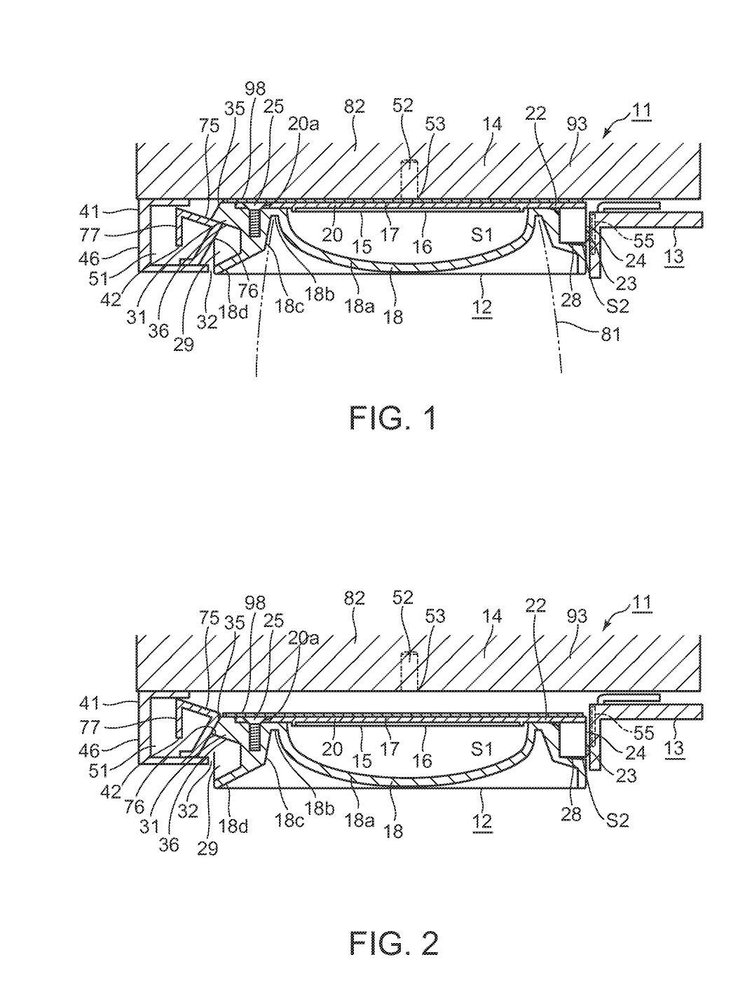

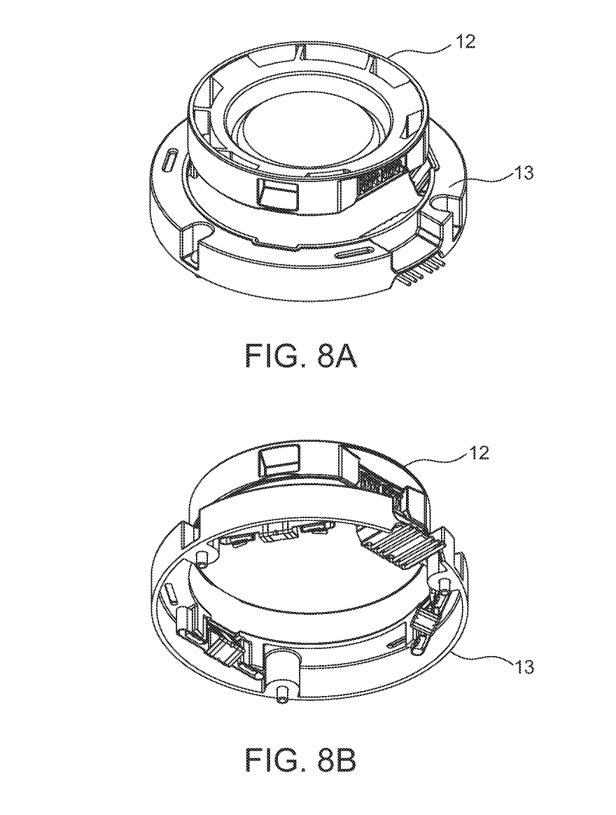

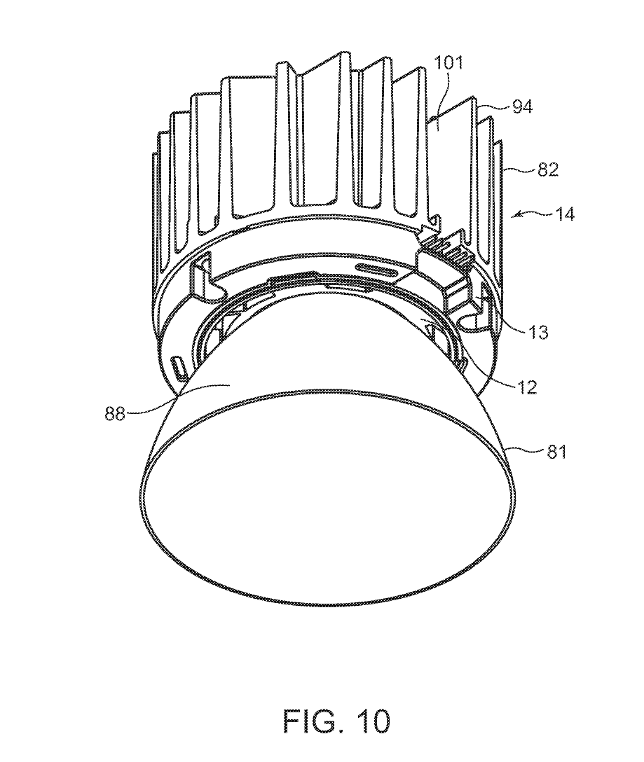

Hereinafter, a structure of an embodiment will be described with reference to FIG. 1 to FIG. 10.

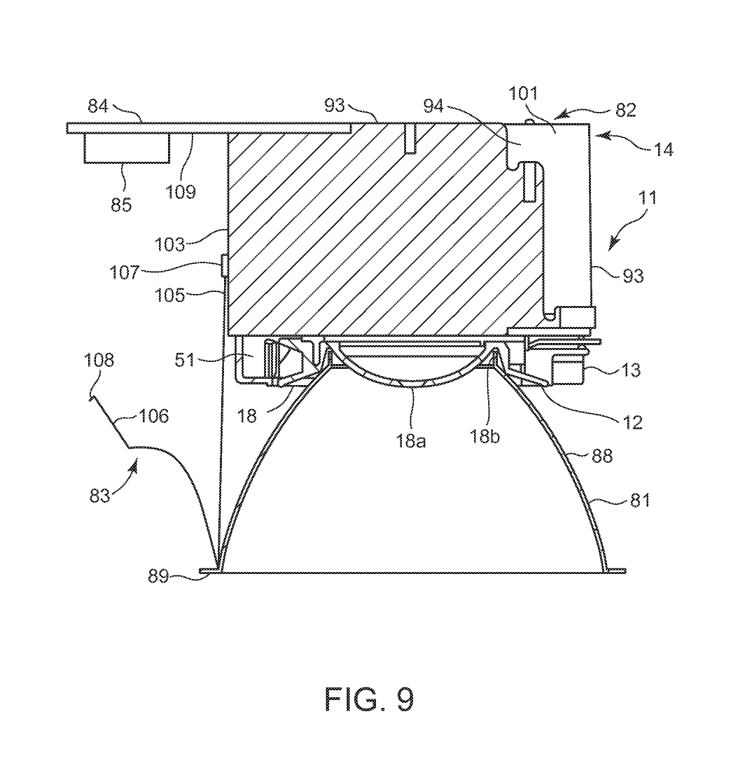

As shown in FIG. 9, a lighting apparatus 11 is an embedded type lighting apparatus such as a down light, and is installed in a state of being embedded in a circular embedded hole provided in an installation target part such as a ceiling plate.

As shown in FIG. 1 to FIG. 10, a flat lamp device 12 used for the lighting apparatus 11, and the lamp device 12 is locked to an apparatus body 14 through a socket 13.

The lamp device 12 includes a light source part 15 using an LED element of a semiconductor light-emitting element (solid light-emitting element), an LED module substrate 16 having a lower surface as one main surface on which the LED element is mounted, an insulating thermal radiation sheet 17 attached to the other main surface side as an opposite light emitting side of the LED module substrate 16, that is, an upper surface side, and a cover 18 as a housing to cover the one main surface side of the LED module substrate 16 (see FIG. 1).

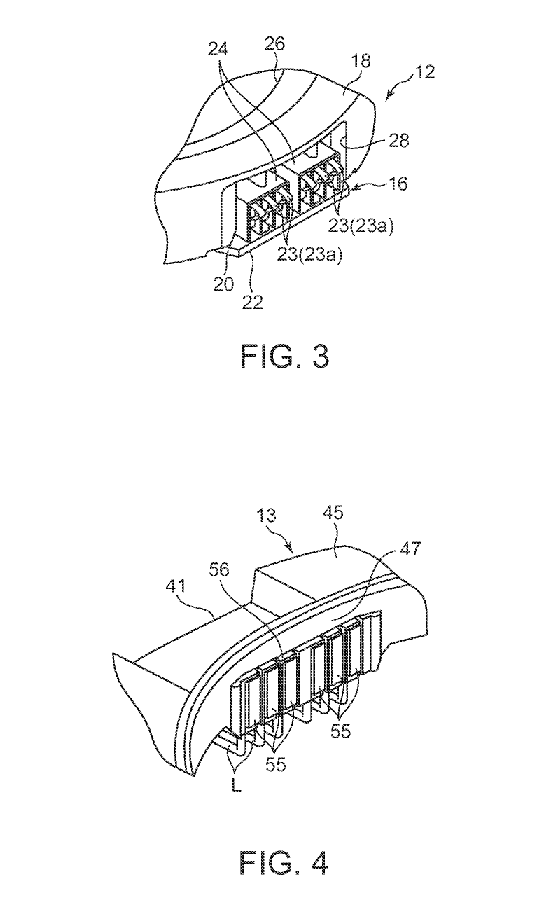

The LED module substrate 16 is, for example, a COB (Chip On Board) type light-emitting module substrate in which LED elements are arranged and mounted in a matrix form on a substrate body 20 formed in a circular shape. Besides, a square protrusion part 22 protruding in a radial direction is protrudingly provided at an edge part of the substrate body 20. A contact part 24 including plural contacts 23 (contact portion) electrically connected to the LED elements is disposed on the protrusion part 22 (see FIG. 3). The LED module substrate 16 is fixed to the cover 18 by a screw 25 as a coupling unit. The substrate body 20 is provided with a step part 20a to receive the head of the screw 25. The screw 25 does not protrude in a state where the cover 18 and the substrate body are coupled by the screw 25.

The contacts 23 are arranged on the protrusion part 22 to be separated from each other in a direction crossing (orthogonal to) the radial direction of the substrate body 20.

Each of the contacts 23 is formed by bending a thin and long metal piece having conductivity, and a tip part 23a as a lower end part is folded in a loop shape. The tip part 23a protrudes sideways from the protrusion part 22, that is, outward from the cover 18. Besides, the tip part is elastically deformed in a direction (horizontal direction) crossing (orthogonal to) an up-and-down direction (vertical direction) as an installation direction of the lamp device 12 to the socket 13 and applies a spring pressure (see FIG. 3)

The contact part 24 is formed of an insulating material and is formed so that the peripheries of the respective contacts 23 are respectively separated at the protrusion part 22 and the contacts 23 are insulated from each other.

The thermal radiation sheet 17 has an electrical insulation property, and for example, a silicone sheet which is soft and is excellent in heat conductivity is used. The thermal radiation sheet 17 is directly attached to the upper surface of the LED module substrate 16, and is thermally connected to the substrate body 20 (and the LED elements) of the LED module substrate 16.

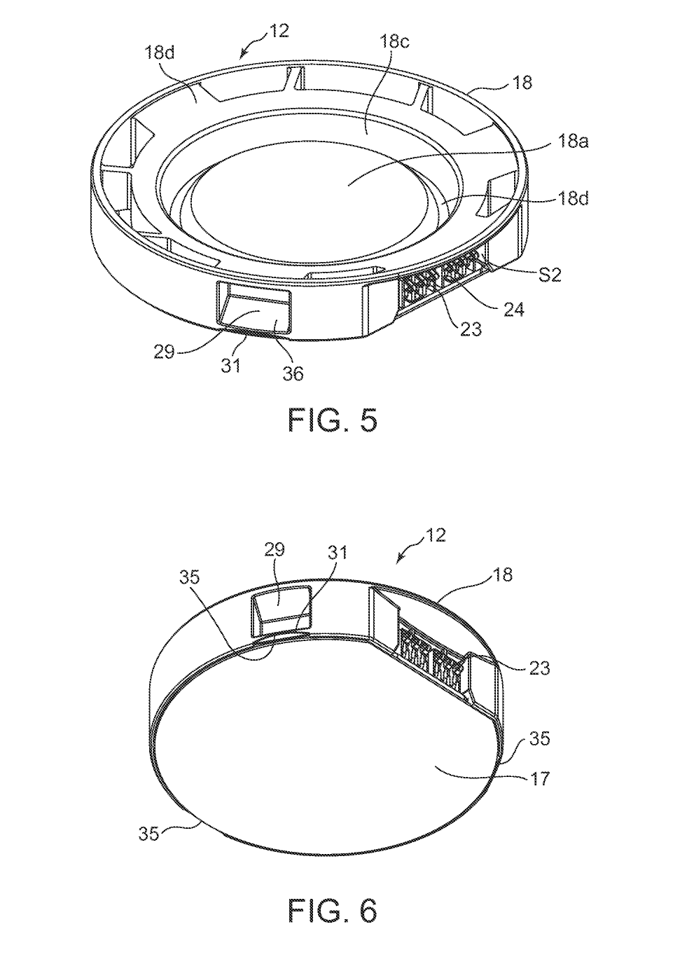

The cover 18 includes a central part 18a formed into a dome shape at a position facing the front surface of the LED module substrate 16, an edge part 18b formed at the periphery of the central part 18a and formed in a concave shape on the substrate body 20 side with respect to the central part 18a, a rising part 18c rising in the protrusion direction of the central part 18a from the edge part 18b, and an outer peripheral part 18d formed outside the rising part 18c, which are formed in one body. The cover 18 is made of, for example, synthetic resin or glass. The central part 18a is translucent and has a light diffusion property, and diffuses and radiates the light, which is irradiated from the LED module substrate 16, forward. By this, the whole central part 18a emits light, and constitutes a light-emitting area wider than the light-emitting part 15 of the LED module substrate 16. That is, the central part 18a functions as a light control body for controlling light. The edge part 18b contacts the substrate body 20 outside the light-emitting part 15. Besides, the contact part 24 is disposed on the substrate body 20 at the position outside the rising part 18c. The light-emitting part 15 and the contact part 24 are spatially separated by the cover 18. That is, the central part 18a, the edge part 18b and the substrate body 20 form a first space S1 accommodating the light-emitting part 15, and the first space is separated from a second space S2 in which the contact part 24 is disposed. An opening part 28 through which the contact part 24 (the contact 23) is exposed to the outside is cut and formed in the outer peripheral part 18d of the cover 18. Further, engagement recess parts 29 as two or more, for example, three engagement parts are formed in the outer peripheral part 18d of the cover 18 and are separated from each other at an equal interval (equal angle) in the circumferential direction (see FIG. 1, FIG. 5, FIG. 6).

The outer peripheral part 18d of the cover 18, together with the substrate body 20, forms a bottom surface of the lamp device. That is, the cover 18 and the substrate body 20 are formed to be flush with each other. The insulating sheet 17 is disposed on the bottom surface of the lamp device 12 formed to be flush, and covers the outer peripheral part 18d of the cover 18 and the substrate body 20. Here, since the head of the screw 25 is received in the step part 20a (recess), the bottom surface of the lamp device 12 is flat.

A locking protrusion 31 as a lamp side locking part for locking the lamp device 12 to the socket 13 (and the apparatus body 14) is provided in each of the engagement recess parts 29 (engagement parts) so as to protrude outward along the radial direction.

Each of the locking protrusions 31 (lamp side locking parts) is positioned in each of the engagement recess parts 29 so that the tip side does not protrude relative to an outer wall of the cover 18. Besides, the upper side of each of the locking protrusions 31 is an upper inclination surface 35 as a lamp side guide surface. The lower side of the locking protrusion 31 is a lower inclination surface 36 as a lamp side locking surface.

The upper inclination surface 35 is positioned at the upper end of the engagement recess part 29, and is inclined downward and outward in the radial direction.

The lower inclination surface 36 is continuous with the lower end of the upper inclination surface 35, and is inclined downward and inward in the radial direction, that is, toward the center side of the cover 18.

The socket 13 includes a socket body 41 formed of, for example, synthetic resin having an insulation property and formed in an annular shape, and a plurality of, for example, three locking units 42 which are arranged in the socket body 41 and are flexure springs as socket side locking parts for locking the lamp device 12 to the socket 13.

An annular part 45 is formed on the socket body 41. Further, an outer edge part 46 extending upward from the outer periphery of the annular part 45 is formed.

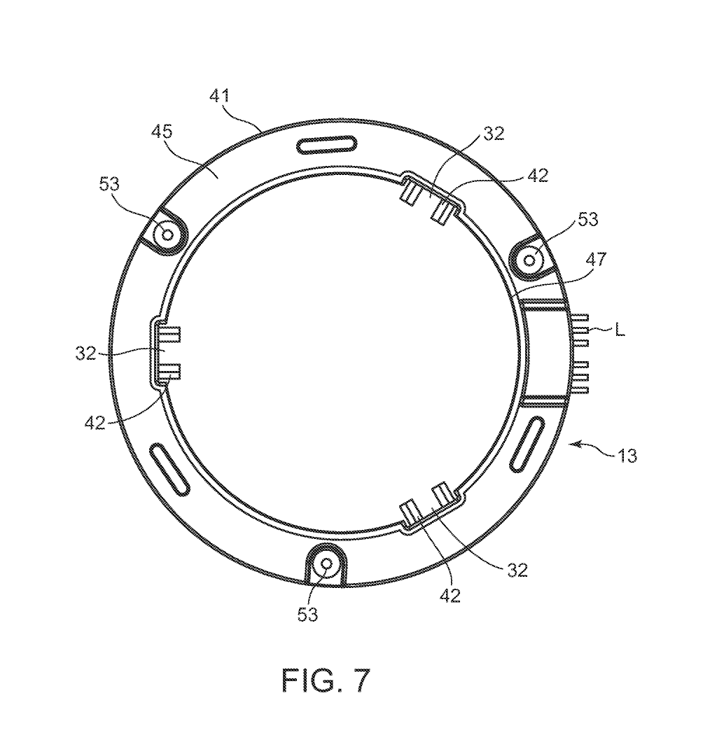

Receiving parts 51 in which the locking units 42 (socket side locking parts) are respectively fitted and received (accommodated) are formed in the annular part 45 along the radial direction and are separated from each other at a substantially equal interval (equal angle) in the circumferential direction. Further, plural boss-shaped screwed parts 53 to which plural screws 52 for fixing the socket 13 and the apparatus body 14 are screwed are formed in the vicinities of the respective receiving parts 51 (see FIG. 1, FIG. 7).

Further, an inner wall 47 is formed on the inner circumferential side of the annular part 45. A terminal part 56 provided with terminals 55 with which the tip parts 23 of the contacts 23 of the contact part 24 of the lamp device 12 attached to the socket 13 are brought into press contact and are electrically connected is formed in the inner wall 47 protrudingly in the radial direction and along the circumferential direction (see FIG. 4).

The respective terminals 55 are respectively disposed lengthwise along the up-and-down direction, and are electrically connected to a not-shown outer power supply (lighting circuit) through output lines L electrically connected to the terminals 55 (see FIG. 4). The terminals 55 are electrically connected to the contacts 23 of the lamp device 12, so that power (DC power) for lighting the LED elements is supplied.

Besides, the terminal part 56 is formed of an insulating material and is formed so that the peripheries of the respective terminals 55 are respectively separated and the terminals 55 are insulated from each other.

Each of the locking units 42 is formed of a bent plate spring. One end thereof contacts the annular part 45 and is supported. A lower inclination surface 76 is formed to protrude from the one end obliquely upward toward the inside of the socket body 41 and functions as a socket side guide surface. An upper inclination surface 75 is formed to be continuous with an upper end of the lower inclination surface 76 and obliquely upward toward the outer edge part 46. A vertical surface 77 is formed to extend downward from an upper end of the upper inclination surface 75. Here, one end of the vertical surface 77 is connected to the upper inclination surface 75 and the other end is not fixed. Thus, the locking unit is elastically deformed outward around the one end of the locking unit 42, and can be received in the receiving part 51 (see FIG. 1).

An opening part 32 is provided inside the annular part 45, so that a gap from the lamp device is formed at the position of the locking unit 42. By this, in the state where the lamp device 12 is installed, a tool is inserted from the opening part 32 to elastically deform the locking unit 42. As a result, the fitting between the locking unit 42 and the lamp device 12 is released, and the lamp device 12 can be detached from the socket 13.

That is, in the socket 13, the opening part 32 into which the tool to release the engagement between the locking unit 42 and the lamp device 12 can be inserted is provided at the position corresponding to the locking unit 42.

The apparatus body 14 includes a reflector 81, a thermal radiator 82 disposed on an upper part of the reflector 81, plural attachment springs 83 attached to the peripheral surface of the thermal radiator 82, an attachment plate 84 attached to an upper part of the thermal radiator 82, and plural terminal stands 85 (only one is shown) attached to the attachment plate 84 (see FIG. 9).

The reflector 81 includes a cylindrical body part 88 made of, for example, metal, and an annular flange part 89 protruding circumferentially from the lower end of the body part 88.

The diameter of the body part 88 is smaller than the diameter of an embedded hole, and the diameter of the flange part 89 is larger than the diameter of the embedded hole. The diameter of the body part 88 gradually increases from the upper side to the lower side.

The thermal radiator 82 is formed of a material such as metal, for example, die-cast aluminum, ceramics, or resin excellent in thermal radiation property. The thermal radiator 82 includes a cylindrical base part 93, and plural thermal radiation fins 94 radially protruding from the periphery of the base part 93.

Gaps 101 opening to the outer periphery, the lower surface and the upper surface of the thermal radiator 82 are formed between the plural thermal radiation fins 94.

Plural attachment parts 103 are formed on the periphery of the base part 93 of the thermal radiator 82. Not-shown attachment holes to which the respective screws 52 to fix the socket 13 are screwed are formed below the respective attachment parts 103.

The attachment spring 83 is formed of a metal plate spring, and includes a support piece 105 and a contact piece 106 bent from a lower end of the support piece 105. In the attachment spring 83, the upper end of the support piece 105 is fixed to the outside surface of the attachment part 103 of the thermal radiator 82 by a screw 107, and the support piece 105 is disposed along the side surface of the apparatus body 14. The contact piece 106 laterally protrudes from the apparatus body 14, and a substantially L-shaped hook part 108 is formed at the tip of the contact piece 106.

The attachment plate 84 is made of, for example, metal, and is fixed by a not-shown screw in a state of contact with the upper surface of the thermal radiator 82. A terminal stand attachment part 109 laterally protruding from the thermal radiator 82 is formed on the attachment plate 84. The respective terminal stands 85 are attached to the lower surface of the terminal stand attachment part 109. That is, the respective terminal stands 85 are disposed at positions laterally separate from the thermal radiator 82 by the attachment plate 84.

One of the terminal stands 85 is, for example, for power supply and earth, and the other is, for example, for dimming signal. The terminal stands 85 and the socket 13 are connected through not-shown electric wires. The electric wires are connected to the respective terminal stands 85 from the socket 13 through not-shown wiring holes of the apparatus body 14, and the gaps 101 between the thermal radiation fins 94 of the thermal radiator 82.

The upper end of the reflector 81 enters between the center part 18a and the rising part 18c of the lamp device 12, and contacts the edge part 18b. Thus, as compared with a structure in which the socket 13 and the lamp device 12 are surrounded by a reflecting plate, the extraction efficiency of light emitted from the lamp device 12 is improved, and the reflector 81 can be miniaturized.

Besides, even if the height size of the reflector 81 is decreased, a light-shielding angle can be made large. Further, since the light source part 15, together with the cover 18, can be separated from the contacts 23, light and heat influences can be reduced.

Next, assembly of the lighting apparatus 11 will be described.

The socket 13 is fixed to the thermal radiator 82 by the screws 52.

Incidentally, when the socket 13 is attached to the apparatus body 14, electric wires from the socket 13 previously pulled out to the outside from not-shown wiring holes of the apparatus body 14 are connected to the respective terminal stands 85. The attachment plate 84 to which the terminal stands 85 are attached is fixed to the upper part of the thermal radiator 82 by plural screws.

Next, the respective attachment springs 83 are fixed to the side surface of the thermal radiator 82 by the respective screws 107.

A contact surface 98 of the thermal radiator 82 is exposed to the inner wall 47 of the socket 13 and is disposed.

Next, installation of the lamp device 12 to the lighting apparatus 11 will be described.

The lamp device 12 is inserted. The lamp device is pushed in an upward direction as an installation direction in a state where the respective engagement recess parts 29 are aligned with the respective locking units 42 of the socket 13, and is inserted into the socket 13.

At this time, the upper inclination surfaces 35 of the locking protrusions 31 positioned at the respective engagement recess parts 29 of the lamp device 12 contact the lower inclination surfaces 76 of the respective locking units 42 (see FIG. 2). When the lamp device 12 is further pushed up, the lamp device is pushed in along the inclinations of the upper inclination surfaces 35 against the urging of the locking units 42, and the locking units 42 are retracted in the receiving parts 51. When the locking protrusions 31 climb over the lower inclination surfaces 76 upward, the locking units 42 return and advance. The upper inclination surfaces 75 contact and are fitted to the lower inclination surfaces 36 of the locking protrusions 31, and the respective locking units 42 support the lamp device 12 from below (see FIG. 1).

The tip parts 23a of the respective contacts 23 of the lamp device 12 are elastically deformed and are in slide-contact with the respective terminals 55 of the socket 13, so that electrical connection between the respective contacts 23 and the respective terminals 55 is obtained.

As stated above, the lamp device 12 can be attached by one touch by merely pushing the lamp device into the socket 13.

In the installation state of the lamp device 12, the LED module substrate 16 of the lamp device 12 comes in close contact with the contact surface 98 of the thermal radiator 82 through the thermal radiation sheet 17. Heat is efficiently conducted from the lamp device 12 to the thermal radiator 82.

The reflector 81 is attached by a not-shown attachment unit to the lighting apparatus 11 to which the socket 13 and the lamp device 12 are already attached. The upper end of the reflector 81 contacts the edge part 18b of the cover 18. For example, three holes are formed in the socket 13, and the reflector 81 is pulled by a tool and is attached.

Next, installation of the lighting apparatus 11 will be described.

Power supply lines, earth lines, dimming signal lines and the like previously guided to the embedded hole of the installation target part are pulled out downward from the embedded hole and from the installation target part, and are connected to the respective terminal stands 85 of the lighting apparatus 11.

The contact pieces 106 of the respective attachment springs 83 are elastically deformed along the side surface of the apparatus body 14 and are held. In this state, first, the lighting apparatus 11 is inclined so that the terminal stand attachment part 109 of the attachment plate 84 and the terminal stands 85 are directed upward, and the terminal stand attachment part 109 of the attachment plate 84 and the terminal stands 85 are obliquely inserted into the embedded hole. Thereafter, while the lighting apparatus 11 is returned to be horizontal, the thermal radiator 82, the body part 88 of the reflector 81 and the respective attachment springs 83 are inserted in the embedded hole.

When the hook parts 108 of the respective attachment springs 83 moves upper than the embedded hole, the holding of the respective attachment springs 83 is released. By this, the contact pieces 106 of the respective attachment springs 83 extend sideways from the apparatus body 14 by the repelling force to the elastic deformation. The contact pieces 106 contact the upper edge part of the embedded hole and the lighting apparatus 11 is pulled upward. The flange part 89 contacts the lower surface of the installation target part and the installation is completed.

When the lighting apparatus 11 is detached from the installation target part, the lighting apparatus 11 is pulled down against the pulling-up force of the attachment springs 83. While the contact pieces 106 of the respective attachment springs 83 moved lower than the embedded hole are elastically deformed along the side surface of the apparatus body 14, the body part 88 of the reflector and the thermal radiator 82 are moved downward from the embedded hole. Further, similarly to the time of installation, the lighting apparatus 11 is inclined, and the terminal stand attachment part 109 of the attachment plate 84 and the respective terminal stands 85 are moved downward from the embedded hole.

When the lamp device 12 is detached from the lighting apparatus 11, suitable tools (not shown) are inserted in the respective opening parts 32, and locking pawls (tip portion) of the upper locking surfaces 75 of the respective locking units 42 are retracted against the urging force. After the locking of the lamp device 12 is released, the lamp device 12 is detached.

Next, lighting of the lamp device 12 will be described.

DC power is supplied to the respective LED elements from the power supply line through the terminal stands 85, the terminals 55 (output lines L) of the socket 13, and the contacts 23 of the lamp device 12, and the LED elements are lit. Light emitted by the lighting of the LED elements passes through the light control body, if necessary, and outgoes from an outgoing opening of the apparatus body 14.

Besides, heat generated by the LED elements of the LED module substrate 16 at the time of lighting is efficiently conducted to the thermal radiator 82 in close contact through the thermally connected thermal radiation sheet 17 from the substrate body 20 of the LED module substrate 16. The heat is radiated to the air from the surface including the plural thermal radiation fins 94 of the thermal radiator 82.

Besides, part of the heat conducted from the lamp device 12 to the thermal radiator 82 is conducted to the apparatus body 14, the plural attachment springs 83, and the attachment plate 84, and is radiated also from these to the air.

As stated above, in the embodiment, the locking pawls of the locking units 42 are provided, which are urged in the horizontal direction crossing the up-and-down direction as the installation direction of the lamp device 12. When the lamp device 12 is pushed in the insertion direction, the locking unit 42 is retracted against the urging of the locking unit by the contact with the locking protrusion 31 of the lamp device 12. Thereafter, when the locking protrusion 31 climbs over the lower locking part 76, the locking unit is returned and advances by the urging of the locking unit 42 and locks the lamp device 12 by the locking protrusion 31. Thus, the lamp device 12 can be easily installed by merely pushing the lamp device into the socket 13 in the installation direction. As compared with, for example, a structure in which the lamp device 12 is rotated relative to the socket 13 and is installed, the lamp device 12 can be attached to the socket 13 by the simple structure, and the lighting apparatus 11 can be manufactured at low cost.

According to at least one of the embodiments described above, since the engagement parts 29 are provided in the cover 18 of the lamp device 12, the lamp device can be formed by fixing the cover 18 and the substrate body 20. Thus, the number of parts can be reduced and the assembly can be facilitated.

Besides, since the bottom surface of the lamp device is formed of the cover 18 and the substrate body 20, heat can be radiated to the apparatus body which contacts the bottom surface of the lamp device 12, and the insulating property of the substrate body 20 can be secured.

Besides, since the light-emitting part 15 and the contacts 23 are spatially separated by the cover 18, deterioration due to light or heat generation from the light-emitting part 15 can be suppressed.

Besides, the thermal radiation sheet 17 covering the upper surface as the other main surface of the substrate body 20 of the LED module substrate 16 is brought into contact with the thermal radiator 82 and is thermally connected, so that excellent thermal radiation properties can be obtained. Further, the recess part as the insulating part is made to intervene between the terminal 55 of the socket 13 and the thermal radiator 82, so that an insulation distance from the thermal radiator 82 can be secured.

Besides, the lamp device 12 can be easily installed by merely pushing the lamp device into the socket 13 in the installation direction. Thus, the thermal radiation sheet 17 is not required to be hard and slidable to the thermal radiator 82 unlike the structure in which the lamp device 12 is rotated and installed to the socket 13. The thermal radiation sheet is formed of a soft member, such as a silicone sheet, excellent in thermal radiation property (heat conductive property), and can be brought into direct contact with the thermal radiator 82. Thus, increase of heat resistance can be suppressed, heat radiation from the LED module substrate 16 (LED elements) can be directly conducted to the thermal radiator 82 without heat loss from the thermal radiation sheet 17, and excellent thermal radiation properties can be obtained.

Incidentally, in the embodiments, as the light source, in addition to the LED element, an arbitrary one, for example, a semiconductor light-emitting element (solid light-emitting element) such as an organic EL element can be used.

While certain embodiments have been described, these embodiments have been presented by way of example only, and are not intended to limit the scope of the inventions. Indeed, the novel embodiments described herein may be embodied in a variety of other forms; furthermore, various omissions substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lamp device comprising:
a substrate body;
a light source part mounted on the substrate body;
a contact portion which is mounted on the substrate body and is electrically connected to the light source part; and
a cover which accommodates the light source part in a space formed by the cover and the substrate body, is light transmissive at least at a position facing the light source part, and spatially separates the light source part mounted on the substrate body and the contact portion.

2. The device according to claim 1, wherein the cover includes an engagement part engaged with a socket side locking part.

3. The device according to claim 1, wherein the cover includes a central part facing the light source part, and an edge part at a peripheral edge of the central part, the light source part is accommodated in the space formed by the central part, the edge part and the substrate body, and the contact portion and the light source part are spatially separated.

4. The device according to claim 1, wherein the cover includes an outer peripheral part outside the edge part, and the outer peripheral part is provided with an engagement part engaged with a socket side locking part.

5. The device according to claim 1, wherein a central part, an edge part and an outer peripheral part of the cover are provided in one body.

6. The device according to claim 1, wherein the cover, together with the substrate body, constitutes a bottom surface of the lamp device.

7. The device according to claim 1, further comprising an insulating sheet to cover a bottom surface of the lamp device, which is constituted by the substrate body and the cover.

8. The device according to claim 1, wherein the substrate body includes a recess to receives a part of a coupling unit which couples the cover and the substrate body.

9. A lighting apparatus comprising:
an apparatus body;
a lamp device; and
a socket device, wherein
the lamp device includes:
a substrate body;
a light source part mounted on the substrate body;
a contact portion which is mounted on the substrate body and is electrically connected to the light source part; and
a cover which accommodates the light source part in a space formed by the cover and the substrate body, is light transmissive at least at a position facing the light source part, and spatially separates the light source part mounted on the substrate body and the contact portion.

10. The device according to claim 9, wherein the cover includes an engagement part engaged with a socket side locking part.

11. The device according to claim 9, wherein the cover includes a central part facing the light source part, and an edge part at a peripheral edge of the central part, the light source part is accommodated in the space formed by the central part, the edge part and the substrate body, and the contact portion and the light source part are spatially separated.

12. The device according to claim 9, wherein the cover includes an outer peripheral part outside the edge part, and the outer peripheral part is provided with an engagement part engaged with a socket side locking part.

13. The device according to claim 9, wherein a central part, an edge part and an outer peripheral part of the cover are provided in one body.

14. The device according to claim 9, wherein the cover, together with the substrate body, constitutes a bottom surface of the lamp device.

15. The device according to claim 9, further comprising an insulating sheet to cover a bottom surface of the lamp device, which is constituted by the substrate body and the cover.

16. The device according to claim 9, wherein the substrate body includes a recess to receives a part of a coupling unit which couples the cover and the substrate body.

17. The apparatus according to claim 9, wherein the socket device includes
a socket side locking part which is attached to the apparatus body, is retracted against urging by contact with a locking part of the lamp device when the lamp device is pushed in a lamp insertion direction, and then is returned by the urging and advances to be engaged with a locking part of the lamp device, and presses the lamp device to the apparatus body, and
a terminal electrically connected to the contact portion of the lamp device.

18. The apparatus according to claim 9, wherein
the cover of the lamp device has a central part protruding in a light outgoing direction relative to the light source part, and an edge part which is provided at a peripheral edge of the central part and contacts the substrate body, and
a substantially cylindrical reflector is provided, and an end of the reflector positions at the edge part of the cover.

19. The apparatus according to claim 9, wherein the socket device is provided with an opening part, at a position corresponding to a socket side locking part, in which a tool to release engagement between the socket side locking part and the lamp device can be inserted from outside.
